(19) United States
(12) Patent Application Publication
(10) Pub. No.: US 2012/0020265 A1
(43) Pub. Date: Jan. 26, 2012

(54) COMPUTER SYSTEM WITH BLUE-TOOTH REMOTE POWER MANAGEMENT AND CONTROL METHOD THEREOF

(75) Inventors: Li-Chien Wu, Taipei City (TW); Pai-Ching Huang, Taipei City (TW)

(73) Assignee: ASUSTEK COMPUTER INC., Taipei City (TW)

(21) Appl. No.: 13/186,479

(22) Filed: Jul. 20, 2011

(30) Foreign Application Priority Data
Jul. 22, 2010 (TW) 99124211

(51) Int. Cl. H04W 52/02

(52) U.S. Cl. 370/311

(57) ABSTRACT

A computer system is provided and it is capable of communicating with a blue-tooth device. The computer system includes a blue-tooth chipset which stores a media access control (MAC) address of the computer system and the blue-tooth device; and a power management system electrically connected to the blue-tooth chipset. When the blue-tooth device is out of a detectable coverage and the computer system is in a power saving mode, the blue-tooth chipset outputs a first control signal to make the power management system change the power saving mode of the computer system, if the blue-tooth device is detected in the detectable coverage.

### CROSS-REFERENCE TO RELATED APPLICATION

This application claims the priority benefit of Taiwan application serial no. 99124211, filed Jul. 22, 2010. The entirety of the above-mentioned patent application is hereby incorporated by reference herein and made a part of this specification.

### BACKGROUND OF THE INVENTION

1. Field of the Invention

The invention relates to a computer system and, more particularly, to a computer system with a blue-tooth technology.

2. Description of the Related Art

The blue-tooth technology is mainly used as a wireless communication connection between a mobile device and other accessories (such as a mobile phone connects to an earphone or a microphone) with low power consumption and a low cost. Recently, the blue-tooth technology is widely used between different electronic devices (such as a host and a printer) as the wireless communication connection.

FIG. 1 is a schematic diagram showing that a computer system communicates with a mobile phone via the blue-tooth technology as a wireless connection. The computer system 10 includes a host 102, a screen 104, a keyboard 106, and a mouse 108. The host 102 includes a power button 112 and a blue-tooth chipset 110. The mobile phone 12 includes a screen 124, a button set 126 and a blue-tooth chipset 120. To illustrate more conveniently, the host 102 is defined as a master device, and the mobile phone 12 is defined to be a slave device. Moreover, to illustrate the blue-tooth technology more conveniently, a wireless communication connection between the host 102 and the mobile phone 12 at the first time is taken as an example.

When the user connects the host 102 and the mobile phone 12 via the blue-tooth technology at the first time, the environment parameters of the host 102 should be set up first. Generally, the blue-tooth chipset 110 in the host 102 is usually at a shut down mode to save power. Consequently, the user should enable the blue-tooth chipset 110 first. The blue-tooth chipset 110 of the host 102 may be enabled by pressing a certain button (not shown) of the host 102 or executing a program. Then, the user should set an identification name for the host 102. Generally, the identification name of the host 102 may be set via a blue-tooth application of the host 102. For example, if the user sets the identification name of the host 102 to be “blue-tooth master device” via the blue-tooth application, and then, in the process of the wireless communication connection between the host 102 and the mobile phone 12, the name “blue-tooth master device” will represent the host 102.

After the blue-tooth chipset 110 of the host 102 is enabled, the host 102 continuously detects whether there is a blue-tooth device nearby. Recently, the detectable coverage of the blue-tooth technology can reach 100 meters at most. When the host 102 detects that the mobile phone 12 appears in the detectable coverage, the blue-tooth application of the host 102 shows the built-in name of the mobile phone 12 according to its original setting. For example, if the built-in name of the mobile phone 12 is “blue-tooth slave device”, the name “blue-tooth slave device” in the blue-tooth application of the host 102 represents the mobile phone 12. When the blue-tooth application of the host 102 lists the “blue-tooth slave device”, it means the mobile phone 12 is detected by the host 102.

When the mobile phone 12 is detected by the host 102, the host 102 and the mobile phone 12 can be connected via the blue-tooth wireless communication by the blue-tooth application for a user. When the user selects “blue-tooth slave device” as the paring device via the blue-tooth application and inputs a blue-tooth media access control (MAC) address, the screen 124 of the mobile phone 12 shows whether to accept the pairing signal. If the user accepts the pairing requirement and inputs the blue-tooth MAC address via the button set 126 of the mobile phone 12, the pairing and the blue-tooth wireless communication connection between the host 102 and the mobile phone 12 are finished. The host 102 may store the blue-tooth MAC address of the mobile phone 12 in a driver of the blue-tooth chipset 110.

Once the blue-tooth wireless communication connection between the host 102 and the mobile phone 12 finishes at the first time, the host 102 and the mobile phone 12 are on and the distance between the host 102 and the mobile phone 12 is in the detectable coverage, so the blue-tooth, the host 102 and the mobile phone 12 can finish the pairing automatically and the blue-tooth wireless communication connection between the host 102 and the mobile phone 12, and perform various preset profiles.

Besides the function of setting the identification name of the host 102 and achieving the pairing of the mobile phone 12, the blue-tooth application also may have other functions such as the power management. For example, in some blue-tooth applications, when the blue-tooth wireless communication connection between the host 102 and the mobile phone 12 is finished, if the mobile phone 12 is moved out of the detectable coverage of the host 102 for a while, that is, the host 102 cannot detect the mobile phone 12 in a certain time, the blue-tooth application makes the host 102 to enter a power saving mode or a shut down mode to achieve the blue-tooth remote power management to the host 102 by the mobile phone 12. The suspend mode or the shut down mode above may be a S3, S4 or S5 mode of the host 10.

FIG. 2 is a flowchart showing a conventional blue-tooth remote power management. First, the computer system boots up (Step 20); the user starts to pair the computer system and the blue-tooth device (Step 22); the computer system stores the blue-tooth MAC address in the driver (Step 24); the blue-tooth application of the computer system detects whether there is a blue-tooth device according to the blue-tooth MAC address stored in the driver (Step 26); if the computer system cannot detect the blue-tooth device in a certain time, the blue-tooth application makes the computer system enter the suspend mode or the shut down mode (Step 28).

As stated above, since the blue-tooth MAC address of the host 102 connected to the mobile phone 12 is stored in the driver of the blue-tooth chipset 110, once the blue-tooth chipset 110 of the host 102 operates in the suspend mode or the shut down mode, the host 102 cannot use the blue-tooth chipset 110 to communicate with the mobile phone 12. At the moment, even if the mobile phone 12 is moved close to the host 102, since the host 102 is in the suspend mode or the shut down mode, the blue-tooth chipset 110 cannot communicate with the mobile phone 12.

The user should use a mouse 108, the keyboard 106 or the power button 112 of the host 102 to wake up the host 102, and resume the connection between the blue-tooth chipset 110 and the mobile phone 12.

### BRIEF SUMMARY OF THE INVENTION

A computer system with a blue-tooth remote power management and a control method thereof are provided.

A computer system adapted to communicate with a blue-tooth device includes a blue-tooth chipset, a firmware storing a blue-tooth MAC address for pairing the computer system and the blue-tooth device, and a power management system electrically connected to the blue-tooth chipset. When the blue-tooth device is out of a detectable coverage of the blue-tooth chipset and the computer system is in a power saving mode, if the blue-tooth chipset detects that the blue-tooth device is in the detectable coverage, the blue-tooth chipset outputs a first control signal to make the power management system change the power saving mode of the computer system.

A blue-tooth remote power management method applied to a computer system and a blue-tooth device is provided. The computer system and the blue-tooth device are paired in a normal mode and a generated a blue-tooth MAC address is stored in a firmware. The method includes the follow steps: making the computer system enter a power saving mode if the computer system cannot detect the blue-tooth device in a detectable coverage in a certain time; detecting whether the blue-tooth device is in the detectable coverage according to the blue-tooth MAC address stored in the firmware when the computer system is in the power saving mode; and changing the power saving mode of the computer system when the blue-tooth device is detected to moves within the detectable coverage.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing that a conventional computer system communicates with a mobile phone via the blue-tooth wireless connection.

FIG. 2 is a flowchart showing a conventional blue-tooth remote power management.

FIG. 3 is a schematic diagram showing a computer system with a blue-tooth remote power management function in a first embodiment of the invention.

FIG. 4 is a flowchart showing a blue-tooth remote power management in an embodiment of the invention.

FIG. 5 is a schematic diagram showing a computer system with a blue-tooth remote power management function in a second embodiment of the invention.

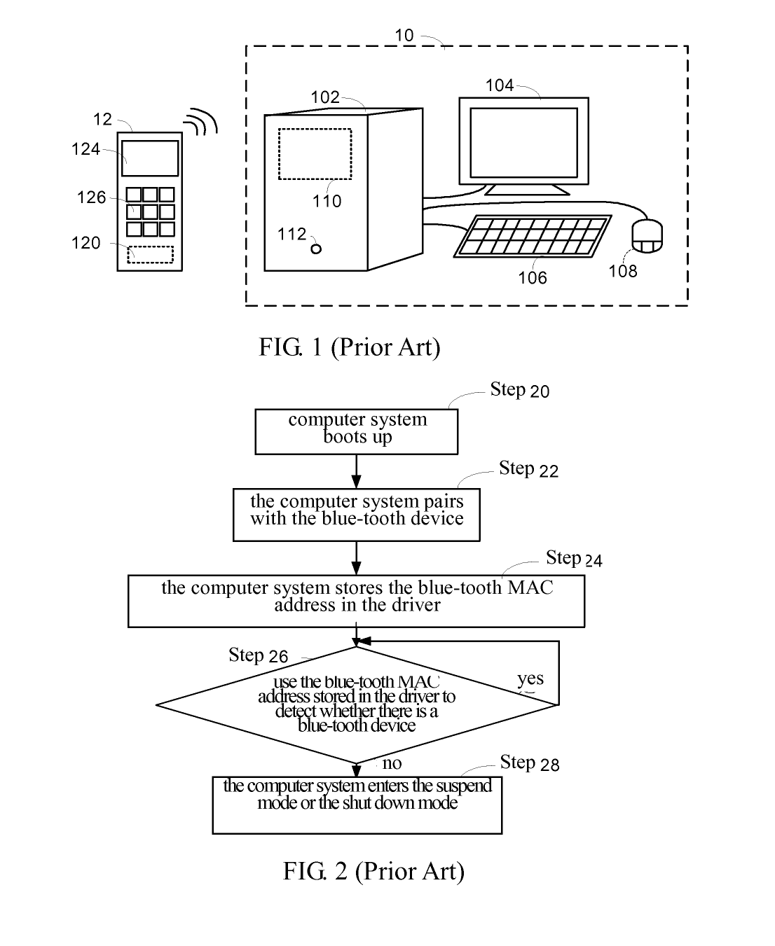

### DETAILED DESCRIPTION OF THE EMBODIMENTS

According to the embodiment of the invention, the blue-tooth MAC address is not only stored in the driver, but also stored in the firmware of the blue-tooth chipset. As a result, when the computer system is in the suspend mode or the shut down mode, the blue-tooth chipset also can receive the standby power and operates normally. Thus, the blue-tooth chipset may detect whether the blue-tooth device is moved close to the computer system again via the blue-tooth MAC address of the firmware, and wake up the computer system.

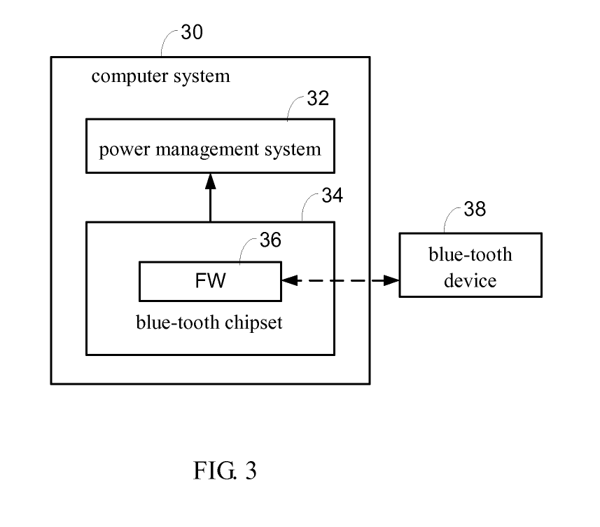

FIG. 3 is a schematic diagram showing a computer system with a blue-tooth remote power management function in a first embodiment of the invention. The computer system 30 in the first embodiment includes a power management system 32 and a blue-tooth chipset 34. The blue-tooth chipset includes a firmware 36. The computer system 30 may be wirelessly connected to a blue-tooth device 38 via the blue-tooth chipset 34.

In the computer system 30 of the first embodiment, when the user start to pair the computer system 30 and the blue-tooth device 38, the blue-tooth MAC address of the computer system 30 and the blue-tooth device 38 is stored in the driver. The blue-tooth MAC address and the detecting parameters (including a detecting time parameter and a distance parameter) are stored in the firmware 36 of the blue-tooth chipset 34. Since when the computer system 30 is in the suspend mode or the shut down mode, the blue-tooth MAC address stored in the firmware 36 of the blue-tooth chipset 34 can be read by the blue-tooth chipset 34. In the first embodiment of the invention, when the computer system 30 operates in the suspend mode or the shut down mode, the blue-tooth chipset 34 can detect whether the blue-tooth device 38 is nearby via the blue-tooth MAC address stored in the firmware 36 of the blue-tooth chipset 34. The suspend mode or the shut down mode above is the S3, S4 or S5 mode of the host 102.

Moreover, when the blue-tooth device 38 is moved out of the detectable coverage of the computer system 30, the blue-tooth application of the computer system 30 cannot detect the blue-tooth device 38 according to the blue-tooth MAC address stored in the driver of the blue-tooth chipset 34, and thus the computer system 30 enters the suspend mode or the shut down mode. If the blue-tooth chipset 34 detects that the blue-tooth device 38 is in the detectable coverage again according to the blue-tooth MAC address stored in the firmware 36, the blue-tooth chipset 34 outputs a first control signal to the power management system 32. Then, the power management system 32 wakes up (resume or boot) the computer system 30 in the suspend mode or the shut down mode according to the first control signal, and makes the computer system 30 reenter the normal mode such as the SO mode. Consequently, the blue-tooth device 38 in the first embodiment of the invention can wake up the computer system 30 from the suspend mode or the shut down mode.

At the moment, since the computer system 30 is woke up and operates in the normal mode, the computer system 30 can reconnected to the blue-tooth device 38 again according to the blue-tooth MAC address stored in the driver of the computer system 30 via the blue-tooth application.

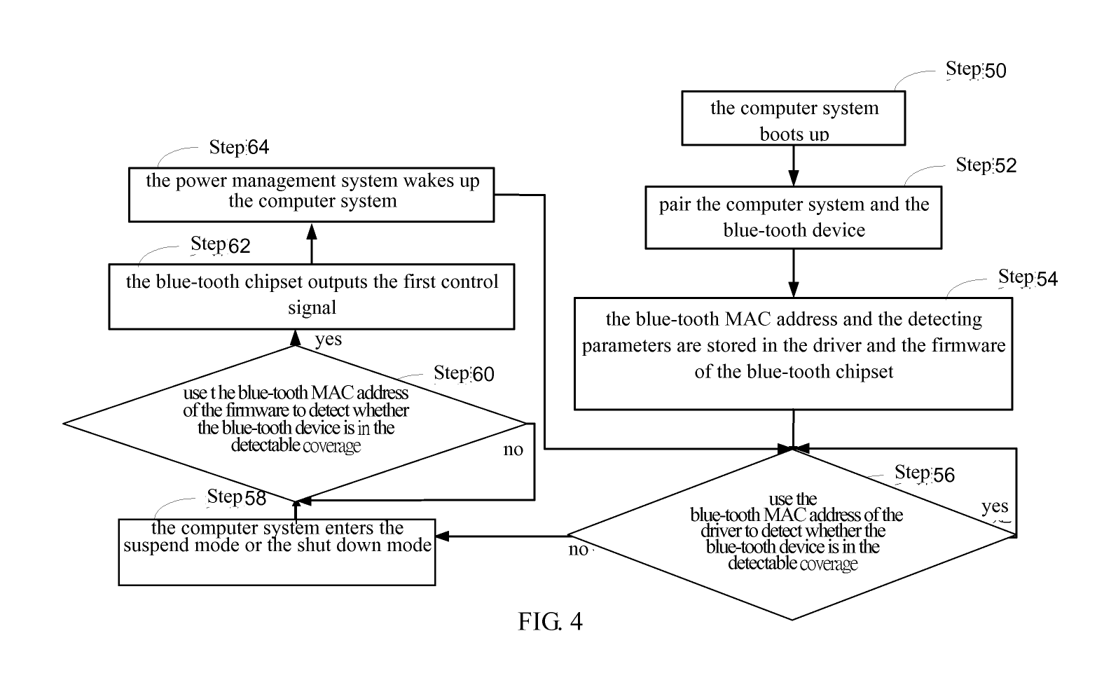

FIG. 4 is a flowchart showing a blue-tooth remote power management in an embodiment of the invention. First, the computer system boots up (Step 50). The user starts to pair the computer system and the blue-tooth device (Step 52). The computer system stores the blue-tooth MAC address and the detecting parameters (including the detecting time parameter and the distance parameter) both in the driver and the firmware of the blue-tooth chipset, and the detecting parameters may be parameters for setting a detecting time and a detectable coverage in the firmware of the blue-tooth chipset (Step 54). The blue-tooth MAC address of the driver is used to detect whether the blue-tooth device is in the detectable coverage (Step 56). If the blue-tooth device cannot be detected in a certain time, the blue-tooth application makes the computer system enter the suspend mode or the shut down mode (Step 58). When the computer system operates in the suspend mode or the shut down mode, the computer system detects whether the blue-tooth device is in the detectable coverage according to the blue-tooth MAC address stored in the firmware of the blue-tooth chipset (Step 60). If the blue-tooth device is detected in the detectable coverage, the blue-tooth chipset outputs the first control signal (Step 62). The power management system wakes up the computer system according to the first control signal (Step 64); At the moment, since the computer system is woke up, the blue-tooth wireless communication connection can be achieved again according to the blue-tooth MAC address stored in the driver of the blue-tooth chipset via the blue-tooth application, and whether the blue-tooth device is in the detectable coverage is detected (Step 56).

In the first embodiment of the invention, the blue-tooth MAC address of the computer system 30 and the blue-tooth device 38 is stored in the firmware 36 of the blue-tooth chipset 34. When the computer system 30 operates in the suspend mode or the shut down mode since the blue-tooth device 38 is out of the detectable coverage of the computer system 30, if the blue-tooth chipset 34 detects that the blue-tooth device 38 is in the detectable coverage again according to the blue-tooth MAC address of the firmware 36 of the blue-tooth chipset 34, the blue-tooth chipset 34 outputs the first control signal to the power management system 32 to make the computer system 30 operate in the normal mode.

The distance parameter of the detecting parameters is stored in the firmware, and if the user sets the detectable coverage to be 5 meters, when the blue-tooth chipset 34 detects the distance between the blue-tooth device 38 and the computer system 30 is smaller than 5 meters according to the blue-tooth MAC address stored in the firmware 36 of the blue-tooth chipset 34, the blue-tooth chipset 34 outputs the first control signal. Furthermore, the blue-tooth chipset 34 can determine the distance to the blue-tooth device 38 by the signal strength outputted by the blue-tooth device 38.

The detecting time parameter can also be stored in the firmware, and the time parameter defines the time for detecting the blue-tooth device by the blue-tooth chipset. If the user sets the detecting time to be 3 seconds, that is, when the computer system enters the suspend mode or the shut down mode, the blue-tooth chipset detects the signal of the blue-tooth device continuously in 3 seconds. If the signal of the blue-tooth device is detected in the predetermined time, the first control signal is outputted. If the signal of the blue-tooth device is not detected in the predetermined time, the detecting is repeated.

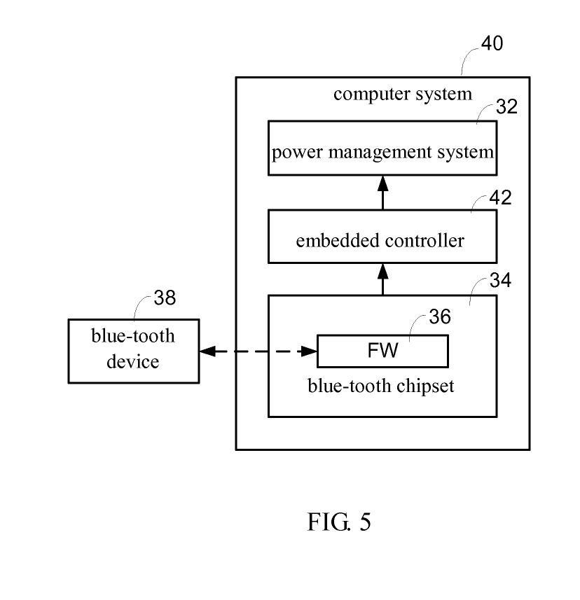

FIG. 5 is a schematic diagram showing a computer system with a blue-tooth remote power management function in a second embodiment of the invention. The computer system 40 in the second embodiment of the invention mainly includes a power management system 32, an embedded controller (EC) 42 and a blue-tooth chipset 34. The EC 42 is connected between the power management system 32 and the blue-tooth chipset 34. Compared to the computer system 30 with the remote power management function in the first embodiment, the difference is that the blue-tooth chipset 34 and the EC 42 receives the standby power to keep operating, even the computer system 40 operates in the suspend mode or the shut down mode since the blue-tooth device 38 is out of the detectable coverage of the computer system 40.

Consequently, if the blue-tooth chipset 34 detects that the blue-tooth device 38 is in the detectable coverage again according to the blue-tooth MAC address of the firmware 36, the blue-tooth chipset 34 outputs the first control signal to the EC 42, and after the EC 42 receives the first control signal, it outputs a second signal to the power management system 32. The power management system 32 wakes up the computer system 40 in the suspend mode or the shut down mode according to the second signal and makes the computer system 40 enter the normal mode. Thus, the blue-tooth device 38 in the second embodiment of the invention can wake up the computer system 40 operating in the suspend mode or the shut down mode.

At the moment, since the computer system 40 is already woke up, the blue-tooth application detects the blue-tooth device 38 to achieve the blue-tooth wireless communication connection again according to the blue-tooth MAC address stored in the driver.

The first control signal may be a wake up signal, and the second signal may be a general purpose input/output (GPIO) signal.

Similarly, in the computer system of the second embodiment, the user may also set the detectable coverage in the firmware of the blue-tooth chipset 34, which is similar to that in the first embodiment and omitted herein.

In sum, in the computer system of the embodiment, since the blue-tooth MAC address of the computer system and the blue-tooth device is also stored in the firmware of the blue-tooth chipset, when the user start to pair the computer system and the blue-tooth device, even the computer system operates in the suspend mode or the shut down mode, the blue-tooth chipset still can detect whether the blue-tooth device is in the detectable coverage continuously via the blue-tooth MAC address stored in the firmware of the blue-tooth chipset. When the blue-tooth device is detected in the detectable coverage again, the power management system is used to resume the computer system to the normal mode.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A computer system adapted to communicate with a blue-tooth device, comprising:
a blue-tooth chipset including a firmware storing a blue-tooth media access control (MAC) address for pairing the computer system and the blue-tooth device; and
a power management system electrically connected to the blue-tooth chipset;
when the blue-tooth device is out of a detectable coverage of the blue-tooth chipset and the computer system is in a power saving mode, if the blue-tooth chipset detects that the blue-tooth device is in the detectable coverage, the blue-tooth chipset outputs a first control signal to make the power management system change the power saving mode of the computer system.

2. The computer system according to claim 1, wherein the power saving mode is a suspend mode or a shut down mode.

3. The computer system according to claim 1, wherein the firmware sets a distance parameter, and when the distance between the blue-tooth device and the computer system is smaller than the distance parameter, the blue-tooth chipset detects the blue-tooth device is in the detectable coverage.

4. The computer system according to claim 3, wherein the distance parameter is set by a blue-tooth application of the computer system.

5. The computer system according to claim 1, wherein the firmware sets a time parameter, and the blue-tooth chipset determines whether to output the first control signal according to whether a signal of the blue-tooth device is detected or not in the time parameter.

6. The computer system according to claim 5, wherein the time parameter is set by a blue-tooth application of the computer system.

7. The computer system according to claim 1 further comprising:
an embedded controller (EC) connected between the blue-tooth chipset and the power management system, wherein after the EC receives the first control signal, the EC outputs a second signal to the power management system to make the power management system change the power saving mode of the computer system.

8. The computer system according to claim 7, wherein the first control signal is a wake up signal, and the second signal is a general purpose input/output (GPIO) signal.

9. The computer system according to claim 7, wherein the blue-tooth chipset and the EC use a standby power.

10. The computer system according to claim 1, wherein the power management system changes the power saving mode of the computer system to make the computer system enter a normal mode from the power saving mode.

11. The computer system according to claim 1, wherein the blue-tooth chipset uses a standby power.

12. A blue-tooth remote power management method applied to a computer system and a blue-tooth device, wherein the computer system and the blue-tooth device are paired in a normal mode and generated a blue-tooth MAC address is stored in a firmware, the method comprising:
making the computer system enter a power saving mode if the computer system cannot detect the blue-tooth device in a detectable coverage in a certain time;
detecting whether the blue-tooth device is in the detectable coverage according to the blue-tooth MAC address stored in the firmware when the computer system is in the power saving mode; and
changing the power saving mode of the computer system when the blue-tooth device is detected in the detectable coverage.

13. The blue-tooth remote power management method according to claim 12, wherein the power saving mode is a suspend mode or a shut down mode.

14. The blue-tooth remote power management method according to claim 12, wherein the firmware stores a distance parameter, and when the distance between the blue-tooth device and the computer system is smaller than the distance parameter, the blue-tooth device is detected to enter the detectable coverage.

15. The blue-tooth remote power management method according to claim 12, wherein the firmware sets a time parameter and a blue-tooth chipset determines whether to output the first control signal according to whether the blue-tooth device is detected in the time parameter.

16. The blue-tooth remote power management method according to claim 12, wherein the power saving mode of the computer system is changed to make the computer system enter the normal mode from the power saving mode.

17. The blue-tooth remote power management method according to claim 12, wherein a blue-tooth chipset sends a first control signal to a power management system to change the power saving mode of the computer system.

18. The blue-tooth remote power management method according to claim 12, wherein a blue-tooth chipset sends a first control signal to an EC, and then the EC sends a second signal to a power management system to change the power saving mode of the computer system.

19. The computer system according to claim 18, wherein the first control signal is a wake up signal, and the second signal is a GPIO signal.
